(19) United States
(12) Patent Application Publication
(10) Pub. No.: US 2024/0275418 A1
(43) Pub. Date: Aug. 15, 2024

(54) EXCEPTIONS TO REGION-SPECIFIC RADIO FREQUENCY EXPOSURE PARAMETERS

(71) Applicant: QUALCOMM Incorporated, San Diego, CA (US)

(72) Inventors: Troy CURTISS, Boulder, CO (US); Jagadish NADAKUDUTI, Bermuda Dunes, CA (US); Lin LU, San Diego, CA (US); Scott HOOVER, Del Mar, CA (US); Akhil DEODHAR, Louisville, CO (US); Nandhini SRINIVASAN, San Diego, CA (US); Paul GUCKIAN, La Jolla, CA (US)

(21) Appl. No.: 18/436,929

(22) Filed: Feb. 8, 2024

Related U.S. Application Data
(60) Provisional application No. 63/484,409, filed on Feb. 10, 2023.

(51) Int. Cl. H04B 1/3827; H04W 52/22; H04W 52/36

(52) U.S. Cl. CPC H04B 1/3838; H04W 52/225; H04W 52/367

(57) ABSTRACT

Certain aspects of the present disclosure provide techniques and apparatus for exceptions to region-specific radio frequency parameters. An example method of wireless communication includes identifying a region in which the wireless device is located. The method further includes identifying an indication, associated with the identified region, of whether to apply one or more exception values or one or more default values, associated with one or more parameters for radio frequency (RF) exposure compliance. The method also includes selecting the one or more exception values based on the indication and transmitting a signal at a transmit power based at least in part on the selected one or more exception values.

### CROSS-REFERENCE TO RELATED APPLICATION

This application claims the benefit of U.S. Provisional Patent Application Ser. No. 63/484,409, filed Feb. 10, 2023, which is hereby incorporated by reference herein in its entirety for all applicable purposes.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modem wireless communication devices (such as cellular telephones) are generally mandated to meet radio frequency (RF) exposure limits set by certain governments and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

Certain aspects of the subject matter described in this disclosure can be implemented in a method for wireless communication by a wireless device. The method generally includes identifying a region in which the wireless device is located. The method also includes identifying an indication, associated with the identified region, of whether to apply one or more exception values or one or more default values, associated with one or more parameters for radio frequency (RF) exposure compliance. The method also includes selecting the one or more exception values based on the indication. The method further includes transmitting a signal at a transmit power based at least in part on the selected one or more exception values.

Certain aspects of the subject matter described in this disclosure can be implemented in an apparatus for wireless communication. The apparatus generally includes one or more memories collectively storing executable instructions and one or more processors coupled to the one or more memories. The one or more processors are collectively configured to execute the executable instructions to cause the apparatus to identify a region in which the apparatus is located, identify an indication, associated with the identified region, of whether to apply one or more exception values or one or more default values, associated with one or more parameters for radio frequency (RF) exposure compliance, select the one or more exception values based on the indication, and control transmission of a signal at a transmit power based at least in part on the selected one or more exception values.

Certain aspects of the subject matter described in this disclosure can be implemented in an apparatus for wireless communication. The apparatus generally includes means for identifying a region in which the wireless device is located. The apparatus also includes means for identifying an indication, associated with the identified region, of whether to apply one or more exception values or one or more default values, associated with one or more parameters for radio frequency (RF) exposure compliance. The apparatus also includes means for selecting the one or more exception values based on the indication. The apparatus further includes means for transmitting a signal at a transmit power based at least in part on the selected one or more exception values.

Certain aspects of the subject matter described in this disclosure can be implemented in a computer-readable medium. The computer-readable medium has instructions stored thereon, that when executed by an apparatus, cause the apparatus to perform an operation. The operation generally includes identifying a region in which the wireless device is located. The operation also includes identifying an indication, associated with the identified region, of whether to apply one or more exception values or one or more default values, associated with one or more parameters for radio frequency (RF) exposure compliance. The operation also includes selecting the one or more exception values based on the indication. The operation further includes transmitting a signal at a transmit power based at least in part on the selected one or more exception values.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a graph illustrating examples of transmit powers over time in compliance with a RF exposure limit, in accordance with certain aspects of the present disclosure.

FIG. 4 illustrates a diagram of example wireless device locations relative to a profile of an example human body, in accordance with certain aspects of the present disclosure.

FIG. 5 is a diagram illustrating an example system for measuring RF exposure values or distributions associated with a wireless communication device, in accordance with certain aspects of the present disclosure.

FIG. 6 is a diagram illustrating an example data structure for selecting exception or default values(s) corresponding to certain RF exposure parameter(s) associated with one or more regions, in accordance with certain aspects of the present disclosure.

FIG. 7 is a table illustrating example mappings between mobile country code (MCC) lists and various RF exposure parameters and exceptions thereof, in accordance with certain aspects of the present disclosure.

FIG. 8 is a table illustrating example mappings between various transmit scenarios and values associated with a RF exposure parameter, in accordance with certain aspects of the present disclosure.

FIG. 9 is a signaling flow illustrating example operations for configurable RF exposure compliance based on a region, in accordance with certain aspects of the present disclosure.

FIG. 10 is a flow diagram illustrating example operations for wireless communication by a wireless device, in accordance with certain aspects of the present disclosure.

FIG. 11 illustrates a communications device that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for configurable radio frequency (RF) exposure compliance based on a region.

Different regions or regulatory/standards bodies (e.g., the Federal Communications Commission (FCC) for the United States; the Innovation, Science and Economic Development Canada (ISED) for Canada; or the International Commission on Non-Ionizing Radiation Protection (ICNIRP) guidelines followed by the European Union (EU)) may specify separate RF exposure compliance limits (e.g., a specific absorption rate (SAR) and/or power density (PD)). The different regions or regulatory/standards bodies may also specify separate time windows for averaging or otherwise calculating RF exposure. A wireless communication device may be configured to use an RF exposure limit that complies with multiple regions, such as the lowest RF exposure limits and/or smallest time window, even if the wireless device is operating in a region with greater RF exposure limits or a larger time window.

Compared to the FCC regulations, ICNIRP guidelines have a much wider international footprint (e.g., multiple countries have adopted ICNIRP guidelines for limiting RF exposure) that covers many different regions. However, some regions, which apply ICNIRP guidelines, may enforce standards and procedures that differ from the ICNIRP guidelines in certain situations (e.g., body-worn exposure and/or hot spot exposure). This patchwork of enforcement levels across regions associated with the ICNIRP guidelines makes it difficult for wireless device manufacturers to apply a single set of RF exposure limits for ICNIRP cases, due to the different level of procedure enforcement, and may result in wireless device manufacturers applying exposure limits that are overly conservative (e.g., unnecessarily low RF exposure limit) in some regions. As such, in certain situations, the wireless device may have an undesirable transmit power due to the application of the lower RF exposure limit and/or time window. The resulting transmit power may lead to undesirable performance, for example, in terms of throughput, latency, and/or transmit range.

Aspects of the present disclosure provide various apparatus and methods for region configurable RF exposure compliance. For example, a wireless device may identify the region in which the wireless device is located or operating and select various settings for RF exposure compliance based on the region. Some settings may correspond to exceptions to default values. In certain aspects, the region may be identified by a mobile country code (MCC) associated with a wireless network identity (e.g., a public land mobile network (PLMN)). In certain cases, the wireless device may select a time window and/or an RF exposure limit based on the region. For example, the wireless device may select the time window and/or the RF exposure limit that matches the regulatory values used in the region. In certain cases, some region(s) may apply an exception (e.g., a variation) to certain default values associated with certain RF exposure parameter(s) used in other region(s), where some of the default values may be shared among the regions. The exception may be mapped to a particular region via a tag, and a look-up table of RF exposure parameters (e.g., maximum time-averaged transmit power per exposure scenario) may include default values and exception values associated with the tag.

The region configurable RF exposure compliance as described herein may enable the wireless device to have improved communication performance, such as an increased throughput, reduced latency, and/or increased transmit range, as illustrative, non-limiting examples. For example, the region configurable RF exposure compliance as described herein may provide the wireless device with a maximum transmit power limit that matches the values applied in the region in which the wireless device is located rather than a lower value that complies with multiple regions. The wireless device may be more flexible to configure specific parameters for RF exposure compliance for a given region, which may lead to desirable transmit power limits in that given region.

The following description provides examples of RF exposure compliance in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs, or may support multiple RATs.

The techniques described herein may be used for various wireless networks and radio technologies. While aspects may be described herein using terminology commonly associated with 3G, 4G, and/or new radio (NR) (e.g., 5G NR) wireless technologies, aspects of the present disclosure can be applied in other generation-based communication systems and/or to wireless technologies such as 802.11, 802.15, etc.

### Example Wireless Communication Network and Devices

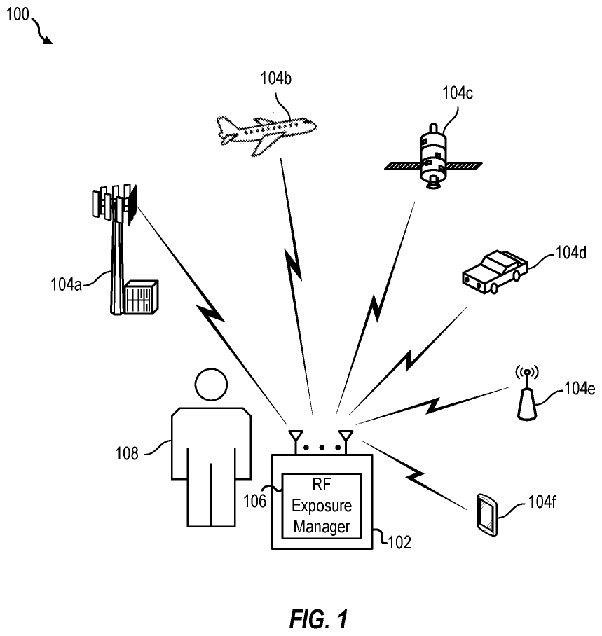

FIG. 1 illustrates an example wireless communication network 100 in which aspects of the present disclosure may be performed. For example, the wireless communication network 100 may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G)/Third Generation (3G) network), or a code division multiple access (CDMA) system (e.g., a 2G/3G network), or may be configured for communications according to an Institute of Electrical and Electronics Engineers (IEEE) standard such as one or more of the 802.11 standards, etc.

As illustrated in FIG. 1, the wireless communication network 100 may include a first wireless device 102 communicating with any of various second wireless devices 104a-f (a second wireless device 104) via any of various RATs, where a wireless device may refer to a wireless communication device. The RATs may include, for example, wireless wide area network (WWAN) communications (e.g., E-UTRA and/or 5G NR), wireless local network (WLAN) communications (e.g., IEEE 802.11), vehicle-to-everything (V2X) communications, non-terrestrial network (NTN) communications, and/or short range communications (e.g., Bluetooth).

The first wireless device 102 may be emitting RF signals in proximity to a human 108, who may be the user of the first wireless device 102 and/or a bystander. As an example, the first wireless device 102 may be held in the hand of the human 108 and/or positioned against or near the head of the human 108. In certain cases, the first wireless device 102 may be positioned in a pocket or bag of the human 108. In some cases, the first wireless device 102 may positioned proximate to the human 108 as a mobile hotspot. To ensure the human 108 is not overexposed to RF emissions from the first wireless device 102, the first wireless device 102 may control the transmit power associated with the RF signals in accordance with an RF exposure limit, as further described herein, where the RF exposure limit may depend on a corresponding exposure scenario (e.g., head exposure, hand (extremity) exposure, body (body-worn) exposure, hotspot exposure, etc.).

The first wireless device 102 may include any of various wireless communication devices including a user equipment (UE), a wireless station, an access point, a customer-premises equipment (CPE), etc. In certain aspects, the first wireless device 102 includes an RF exposure manager 106 that may select certain values for RF exposure parameters that match the RF exposure limits associated with a region, where some values may be an exception to default values, in accordance with aspects of the present disclosure.

The second wireless devices 104a-f may include, for example, a base station 104a, an aircraft 104b, a satellite 104c, a vehicle 104d, an access point 104e, and/or a UE 104f. Further, the wireless communication network 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipments.

The base station 104a may generally include: a NodeB (NB), enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the first wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 gigahertz (GHz). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Note, frequency bands of 24 GHz to 71 GHz are sometimes referred to as a “millimeter wave” (“mmW” or “mmWave”). Thus, different metrics may be used to assess RF exposure for different wireless communication technologies.

A wireless device (e.g., the first wireless device 102) may simultaneously transmit signals using multiple wireless communication technologies and/or frequency bands. For example, the wireless device may simultaneously transmit signals using a first wireless communication technology operating at or below 6 GHz (e.g., 3G, 4G, 5G, 802.11a/b/g/n/ac, etc.) and a second wireless communication technology operating above 6 GHz (e.g., mmWave 5G in 24 to 60 GHz bands, IEEE 802.11ad or 802.11ay). In certain aspects, the wireless device may simultaneously transmit signals using the first wireless communication technology (e.g., 3G, 4G, 5G in sub-6 GHz bands, IEEE 802.11ac, etc.) in which RF exposure is measured in terms of SAR, and the second wireless communication technology (e.g., 5G in 24 to 71 GHz bands, IEEE 802.11ad, 802.11ay, etc.) in which RF exposure is measured in terms of PD. As used herein, sub-6 GHz bands may include frequency bands of 300 megahertz (MHz) to 6,000 MHz in some examples, and may include bands in the 6,000 MHz and/or 7,000 MHz range in some examples.

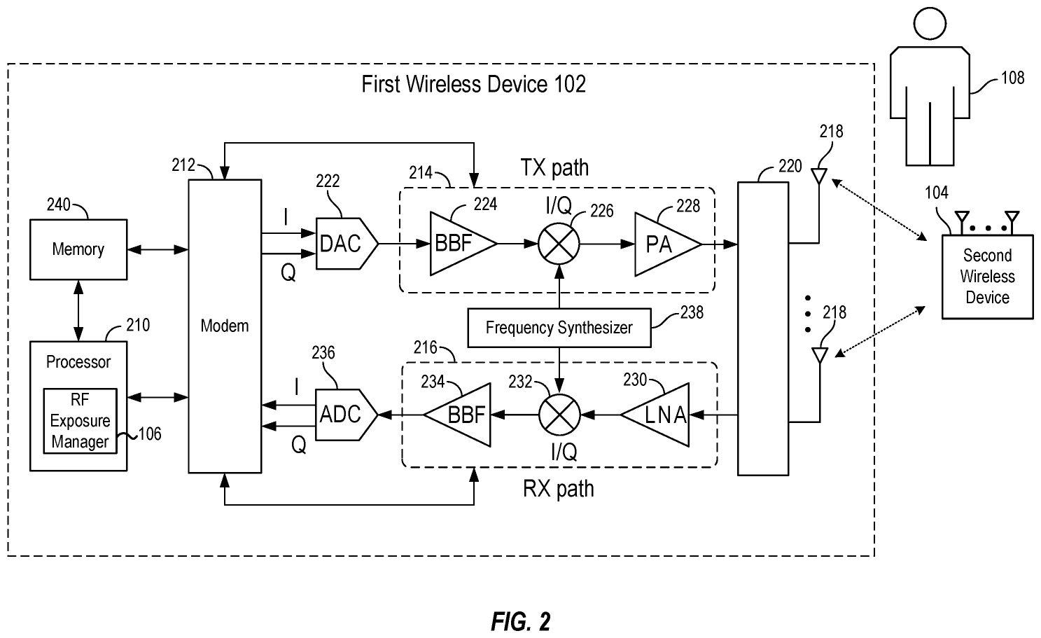

FIG. 2 illustrates example components of the first wireless device 102, which may be used to communicate with any of the second wireless devices 104, in some cases, in proximity to human tissue as represented by the human 108. At the first wireless device 102, a processor 210 may obtain data and/or control information. In certain aspects, the processor 210 may include a baseband processor that processes (e.g., encode and symbol map) the data and control information to obtain data symbols and control symbols, respectively. The processor 210 may perform spatial processing (e.g., precoding) on the data symbols, the control symbols, and/or the reference symbols, if applicable, and may provide output symbol streams to a modem 212. In some cases, aspects of the processor 210 may be integrated with (or incorporated in) the modem 212, such as the RF exposure manager 106, a baseband processor, a medium access control (MAC) processor, a digital signal processor, etc.

The modem 212 may be coupled to a transmit (TX) path 214 (also known as a transmit chain) for transmitting signals via one or more antennas 218 and a receive path (RX) 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a digital-to-analog converter (DAC) 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna 218. The antennas 218 may emit RF signals, which may be received at the second wireless device 104. While one mixer 226 is illustrated, several mixers may be used to upconvert the filtered baseband signals to one or more intermediate frequencies and to thereafter upconvert the intermediate frequency signals to a frequency for transmission.

The RX path 216 may include a low noise amplifier (LNA) 230, a mixer 232, and a baseband filter (BBF) 234. RF signals received via the antenna 218 (e.g., from the second wireless device 104) may be amplified by the LNA 230, and the mixer 232 mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals, for example, demodulating the digital signals.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

The processor 210 and/or modem 212 may control the transmission of signals via the TX path 214 and/or reception of signals via the RX path 216. In some aspects, the processor 210 and/or modem 212 may be configured to perform various operations, such as those associated with the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented on the processor 210 and/or modem 212) may determine a transmit power (e.g., corresponding to certain levels of gain(s) applied to TX path 214 including the BBF 224, the mixer 226, and/or the PA 228) that complies with an RF exposure limit set by country-specific regulations and/or international guidelines (e.g., ICNIRP guidelines) as described herein.

Note FIG. 2 shows one reference example of a transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the FCC specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands). The RF exposure limit and/or corresponding averaging time window may vary based on the frequency band. In certain aspects, the RF exposure limit(s) and/or corresponding averaging time window(s) may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum allowed transmit power that can be used by the wireless device.

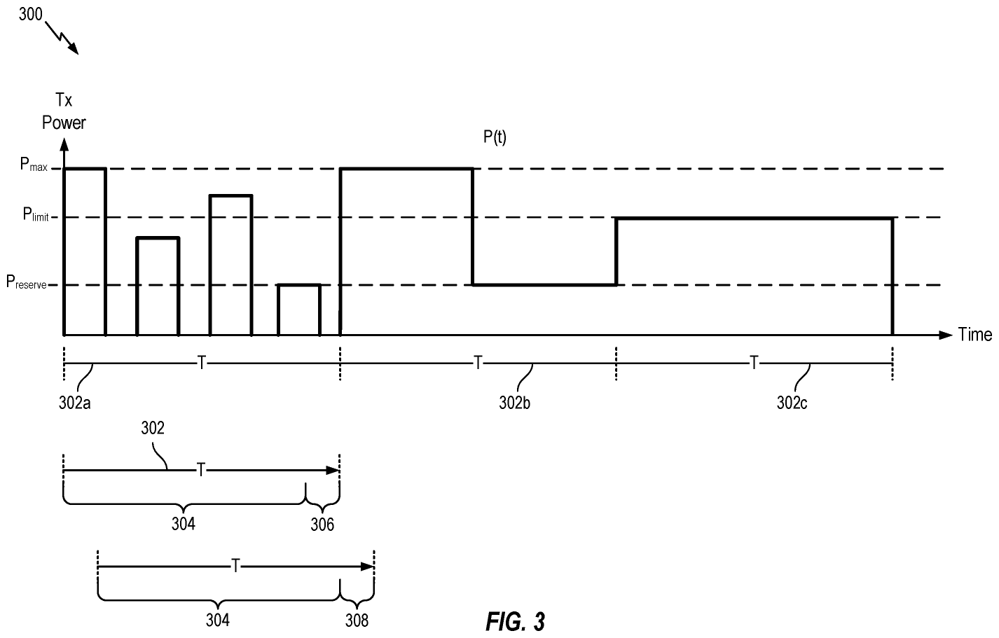

FIG. 3 is a graph 300 of a transmit power over time (P(t)) that varies over a running (e.g., rolling or moving) time window (T) associated with the RF exposure limit. The wireless device (e.g., the first wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, for example, in the next future time interval 308, where the past time interval 304 now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the third time window 302c such that the time-averaged transmit power over the time window (e.g., the third time window 302c) is equal to Pₗᵢₘᵢₜ in compliance with the time-averaged RF exposure limit.

In certain cases, an instantaneous transmit power may exceed Pₗᵢₘᵢₜ in certain transmission occasions, for example, as shown in the first time window 302a and the second time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, P_{CMAX}). In some cases, the wireless device may transmit at a transmit power less than or equal to Pₗᵢₘᵢₜ in certain transmission occasions, for example, as shown in the first time window 302a.

In certain cases, a reserve power may be used to enable a continuous transmission within a time window (T) when transmitting above Pₗᵢₘᵢₜ in the time window. As shown in the second time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the third time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling). Pᵣₑₛₑᵣᵥₑ may also be referred to as a “control power level” or “control level.”

In the second time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the area of transmit power (P(t)) in the second time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘa for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘa in the time-average mode illustrated in the second time window 302b. While a single transmit burst is illustrated in the second time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 ms) of a specific period (e.g., 500 ms) in which the wireless device transmits RF signals. The duty cycle may be a ratio of the share to the specific period (e.g., 5 ms/500 ms), where the duty cycle may be represented as a number from zero to one. For example, in the first time window 302a, the duty cycle may be greater than 50% of the duration of the time window (T), whereas in the second time window 302b, the duty cycle may be equal to 100% of the duration of the time window (T). In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

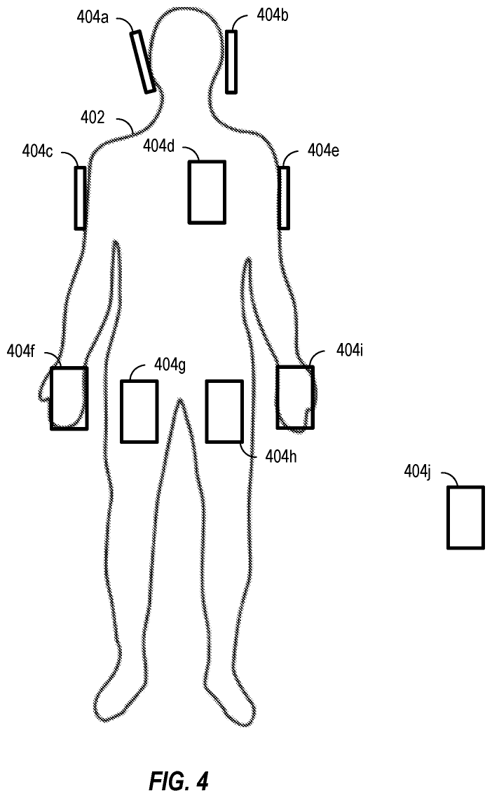

Depending on use case (e.g., user behavior), over time, a wireless communication device may expose different human tissue or different parts of the human body to RF energy at different times. FIG. 4 illustrates a diagram of example wireless device locations 404a-j relative to a profile of an example human body 402. For example, in a first occasion, the wireless device may be held next to the head of a user for a voice call (e.g., at location 404a, 404b), where the RF exposure is to the head (and potentially to a hand holding the phone); and in a second period of time, the user may switch to using Bluetooth for the voice call and place the wireless device in a pocket (e.g., at location 404d, 404g, 404h), where the RF exposure in the second occasion is to both head (from a Bluetooth radio) and torso (from the wireless device). At other times, the user may position the wireless device in other locations, such as any of locations 404c-j.

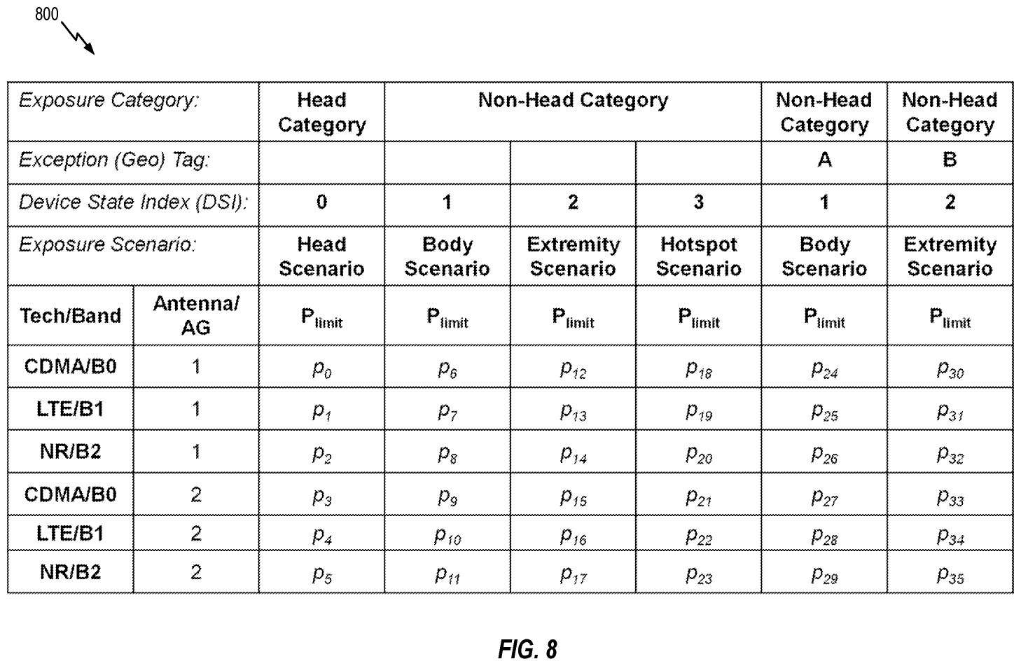

In certain aspects, the locations 404a-j may correspond to certain exposure scenarios (or exposure categories), where a particular exposure scenario (or exposure category) may apply separate transmit power limit(s) from another exposure scenario (or exposure category) as further described herein with respect to FIG. 8. The exposure scenarios may include a head exposure scenario, where the head of a user is exposed to RF energy by the wireless device, for example, corresponding to locations 404a, 404b. The exposure scenarios may include a body-worn (or body) exposure scenario, where the body or torso of the user is exposed to RF energy by the wireless device, corresponding to locations 404d, 404g, 404h. The exposure scenarios may include an extremity exposure scenario, where the hand or arm of the user is exposed to RF energy by the wireless device, corresponding to locations 404c, 404e, 404f, 404i. The exposure scenarios may include a hotspot exposure scenario, where the wireless device is not held or worn on the user's body, corresponding to location 404j. Each of the various exposure scenarios described herein may correspond to a unique device state index (DSI). It will be appreciated that other exposure scenarios may be applied for RF exposure compliance.

In some cases, each of the exposure scenarios may be associated with one or more DSIs. For example, a head exposure scenario may be associated with a DSI equal to 0; a body-worn exposure scenario may be associated with a DSI equal to 1; an extremity exposure scenario may be associated with a DSI equal to 2; and a hotspot exposure scenario may be associated with a DSI equal to 3. In certain cases, multiple exposure scenarios may be associated with the same DSI. Other alignments of exposure scenarios to DSI or indexing/associating schemes may be used in addition to or instead of the DSI to exposure scenario associations described herein.

Although ten different locations 404a-j are shown in FIG. 4, it will be understood that there may be other locations in addition to or instead of the locations 404a-j being assessed for exposure. The number of different locations used for RF exposure tracking may depend, for example, on the sensing and/or memory capabilities of the wireless device, on the desired tissue exposure tracking resolution, etc. The locations 404a-j may be used, in some examples, to identify a part of a user which is exposed with greater specificity than may be possible with a DSI or exposure category. In some examples, the locations 404 include a right side of the head (e.g., 404a), a left side of the head (e.g., 404b), a right hand (e.g., 404f), and left hand (e.g., 404i), etc.

### Example RF Exposure Measurements

In certain cases, the RF exposure of a wireless device may be certified with a regulatory agency (e.g., the FCC for the United States or the ISED for Canada). Spatial measurements may be taken with respect to a model (phantom) representing the human body, where the model may be filled with a liquid simulating human tissue. As discussed above, the first wireless device 102 may simultaneously transmit signals using the first technology (e.g., 3G, 4G, IEEE 802.11ac, etc.) and the second technology (e.g., 5G, IEEE 802.11ad, etc.), in which RF exposure is measured using different metrics for the first technology and the second technology (e.g., SAR for the first technology and PD for the second technology). The RF exposure measurements may be performed differently for each transmit scenario and include, for example, electric field measurements using a model of a human body. RF exposure values and/or distributions (simulation and/or measurement) may then be generated per transmit antenna/configuration (beam) on various evaluation surfaces/positions at various locations.

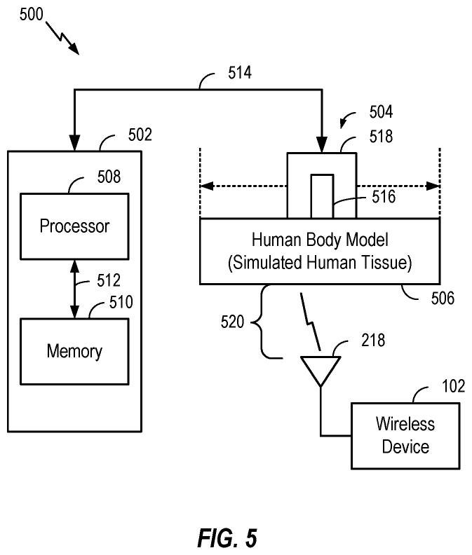

FIG. 5 is a diagram illustrating an example system 500 for measuring RF exposure values or distributions associated with a wireless communication device (e.g., the first wireless device 102). As shown, the RF exposure measurement system 500 includes a processing system 502, a (robotic) RF probe 504, and a human body model 506. The RF exposure measurement system 500 may take RF measurements at various transmit scenarios (e.g., frequency band, antenna, and/or beam) and/or exposure scenarios (e.g., head exposure, body exposure, extremity exposure, and/or hotspot exposure) associated with the first wireless device 102. In some examples, these measurements may be used to generate an RF exposure map and assess suitable backoff factors for the transmit powers of the antenna(s) 218 in compliance with one or more RF exposure limits. The first wireless device 102 may emit electromagnetic radiation via the antenna(s) 218 at various transmit powers, and the RF exposure measurement system 500 may take RF measurements via the robotic RF probe 504 (e.g., to determine RF exposure map(s) and/or backoff factors for the antenna(s) 218). Transmit power limits (e.g., Pₗᵢₘᵢₜ) for the various transmit scenarios and/or exposure scenarios associated with the first wireless device 102 may be determined based on the RF measurements and/or exposure maps or backoff factors. Note that while measurements are described as being performed with respect to the wireless device 102, measurements may be taken with respect to a (different) representative device (e.g., a sample device for testing purposes), and then transmit power limits loaded into or otherwise provided or conveyed to the first wireless device 102 (e.g., the devices manufactured for end-users).

In some cases, a test separation distance (or spacing) 520 may be adjusted (increased or decreased) depending on the transmit scenario and/or exposure scenario, where the test separation distance 520 may be the distance between a radiating structure (e.g., the antenna(s) 218) and any part of the human body, in this example, the human body model 506. For example, the test separation distance 520 may be set to 15 millimeters (mm) for body-worn exposure, 0 mm for head exposure, 10 mm for a hotspot exposure, etc. In certain case, the test separation distance 520 may differ among regions. For example, the test separation distance 520 may be set to 0 mm for body-worn exposure for a particular region, whereas the test separation distance 520 may be set to 15 mm for body-worn exposure for another region, and in some cases, using the same RF exposure limit (e.g., 1.6 W/kg averaged over 1 gram). As the test separation distance 520 may differ among some regions, the corresponding transmit power limits (e.g., Pₗᵢₘᵢₜ) may differ among these regions regardless of whether the same RF exposure limit is applied.

The processing system 502 may include a processor 508 coupled to a memory 510 via a bus 512. The processing system 502 may be a computational device such as a computer. The processor 508 may include a microprocessor, a central processing unit (CPU), a graphics processing unit (GPU), a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. The processor 508 may be in communication with the robotic RF probe 504 via an interface 514 (such as a computer bus interface), such that the processor 508 may obtain RF measurements taken by the robotic RF probe 504 and control the position of the robotic RF probe 504 relative to the human body model 506, for example.

The memory 510 may be configured to store instructions (e.g., computer-executable code) that when executed by the processor 508, cause the processor 508 to perform various operations. For example, the memory 510 may store instructions for obtaining the RF exposure values or distributions associated with various RF exposure/transmit scenarios and/or adjusting the position of the robotic RF probe 504.

The robotic RF probe 504 may include an RF probe 516 coupled to a robotic arm 518. In aspects, the RF probe 516 may be a dosimetric probe capable of measuring RF exposures at various frequencies such as sub-6 GHz bands and/or mmWave bands. The RF probe 516 may be positioned by the robotic arm 518 in various locations (as indicated by the dotted arrows) to capture the electromagnetic radiation emitted by the antenna(s) 218 of the first wireless device 102. The robotic arm 518 may be a six-axis robot capable of performing precise movements to position the RF probe 516 to the location (on the human body model 506) of maximum electromagnetic field generated by the first wireless device 102. In other words, the robotic arm 518 may provide six degrees of freedom in positioning the RF probe 516 with respect to the antenna(s) 218 of the first wireless device 102 and/or the human body model 506.

The human body model 506 may be a specific anthropomorphic mannequin with simulated human tissue. For example, the human body model 506 may include one or more liquids that simulate the human tissue of the head, body, and/or extremities. The human body model 506 may simulate the human tissue for determining the maximum permissible transmission power of the antenna(s) 218 in compliance with various RF exposure limits implemented in various regions.

In certain aspects, the RF exposure values or distributions associated with the first wireless device 102 may be measured without the human body model 506. For example, the RF probe 516 may be an electric- or magnetic-field probe capable of estimating the SAR and/or PD exposure encountered by human tissue in the free-space surrounding the first wireless device 102. While the example depicted in FIG. 5 is described herein with respect to obtaining RF exposure values or distributions with a robotic RF probe to facilitate understanding, aspects of the present disclosure may also be applied to other suitable RF probe architectures, such as using multiple stationary RF probes positioned at various locations along the human body model 506 or free-space.

Different regions or regulatory/standards bodies (e.g., the FCC for the United States; the ISED for Canada; or the ICNIRP guidelines followed by the EU) may specify various parameters for limiting RF exposure to human tissue. For example, the regions may specify different RF exposure compliance limits (SAR and PD) (e.g., 1.6 W/kg or 2.0 W/kg), different time-averaging time windows (e.g., 4 seconds, 100 seconds, 360 seconds, etc.), different averaging volumes (e.g., 1 gram or 10 grams) or areas (e.g., 4 cm² area or 20 cm² area), and/or different test separation distances (or spacings) (e.g., 0 mm or 15 mm), as illustrative examples.

These various parameters may be used in measuring the RF exposure associated with a wireless device as described herein with respect to FIG. 5. As an example, in order to determine Pₗᵢₘᵢₜ that complies with FCC regulations, the RF exposure measurements may be taken using a SAR limit of 1.6 W/kg when averaged over 1 g-mass with a test separation distance of 15 mm. To determine a separate Pₗᵢₘᵢₜ for some regions applying ICNIRP guidelines or an exception thereof (as further described herein), the RF exposure measurements may be taken using 2.0 W/kg when averaged over 10 g-mass of human tissue with a test separation distance of 15 mm or 0 mm depending on the RF exposure parameters implemented for that region or the scenario under test. Also, some regulatory bodies (e.g., the ICNIRP in the 2020 guidelines) may specify an additional compliance limit in terms of a brief RF exposure limit.

In the case of sub-6 GHz bands, for head or torso exposure to the general population, the FCC specifies a SAR limit of 1.6 W/kg when averaged over 1 g-mass of human tissue. The ICNIRP 1998 standard has a SAR limit (followed by the EU and many other countries) of 2.0 W/kg when averaged over 10 g-mass of human tissue. The ICNIRP 2020 standard has the same sub-6 GHz exposure limit as the ICNIRP 1998 standard.

In the case of mmWave bands (e.g., bands greater than 6 GHz), for mmWave exposure to the general population, the FCC specifies a PD limit of 10 W/m² when averaged over a 4 cm² area. The ICNIRP 1998 standard specifies a PD limit of 10 W/m² when averaged over a 20 cm² area. The ICNIRP 2020 standard provides a different PD limit.

In addition to RF exposure limits, specific regions allow for time averaging in determining the RF exposure and specify the length of the time window for RF exposure compliance, for example, as described herein with respect to FIG. 3. Time window length specified by regulators may vary with transmit frequency. For example, the FCC specifies a 100-second time window for transmit frequencies less than 3 GHz, a 4-second time window for transmit frequencies between 24 GHz and 42 GHz, etc. The ICNIRP 1998 standard provides a 360-second time window for transmit frequencies less than 6 GHz, and various time window lengths for transmit frequencies greater than 6 GHz. The ICNIRP 2020 standard provides a 360-second time window for all frequency ranges (e.g., from 100 kHz to 300 GHz), and also specifies brief RF exposure limits to control rapid temperature rise.

In addition to RF exposure limits and time windows for averaging, some regulatory standards (e.g., the ICNIRP 2020 standard) may specify a limit on brief RF exposures by limiting the total RF exposure energy for transmissions from any pulse, group of pulses, or subgroup of pulses in a train, as well as from the summation of exposures (including non-pulsed transmissions) within a specified time duration.

Those of skill in the art will understand that the specific values for various parameters (e.g., RF exposure limits, brief RF exposure limits, time windows, averaging volumes, averaging areas, and/or test separation distance) associated with RF exposure compliance described herein are merely examples. Alternative values for the parameters may be used in addition to or instead of those described herein, for example, due to updated standards and/or regulatory requirements for RF exposure compliance adopted by a regulatory body or standard in a specific region. Thus, while it is recited above that the FCC specifies certain values/limits, it will be understood that aspects of the present disclosure described herein are not limited thereto and that aspects of this disclosure may apply to other values/limits from the FCC and/or to other values/limits or other regulatory bodies and/or standards.

In general, a specific region may have a lower RF exposure limit or a smaller time window than other regions. For example, the FCC RF exposure limits (1.6 W/kg 1 g SAR) is lower than the ICNIRP 1998 RF exposure limit (2.0 W/kg 10 g SAR). In other words, a transmit power meeting the FCC RF exposure limit will also meet the ICNIRP 1998 RF exposure limit, but not vice versa.

Compared to the FCC regulations, ICNIRP guidelines have a much wider international footprint (e.g., multiple countries have adopted ICNIRP guidelines for limiting RF exposure) that covers many different regions. However, some regions, which apply ICNIRP guidelines, may enforce standards and procedures that differ from the ICNIRP guidelines in certain situations (e.g., body-worn exposure and/or hot spot exposure). This patchwork of enforcement levels across regions associated with the ICNIRP guidelines makes it difficult for wireless device manufacturers to apply a single set of exposure limits for ICNIRP cases, due to the different level of procedure enforcement, often applying exposure limits that are overly conservative in some regions. As such in certain situations, the wireless device may have an undesirable transmit power due to the application of the lower RF exposure limit and/or time window. The resulting transmit power may lead to undesirable performance, for example, in terms of throughput, latency, and/or transmit range.

### Example Exceptions to Region-Specific RF Exposure Parameters

Aspects of the present disclosure provide various apparatus and methods for region configurable RF exposure compliance. For example, a wireless device may identify the region in which the wireless device is located or operating and select various settings for RF exposure compliance based on the region. Some settings may correspond to exceptions to default values, for example, used in certain region(s) and in certain exposure scenario(s). In certain aspects, the region may be identified by a mobile country code (MCC) associated with a wireless network identity (e.g., a public land mobile network (PLMN)). In certain cases, the wireless device may select a time window and/or an RF exposure limit based on the region. For example, the wireless device may select the time window and/or the RF exposure limit that matches the regulatory values used in the region. In certain cases, some region(s) may apply an exception (e.g., a variation) to default values associated with certain RF exposure parameter(s) (e.g., Pₗᵢₘᵢₜ) used in other region(s). The exception may be mapped to a particular region via a tag, and a look-up table of RF exposure parameters (e.g., maximum time-averaged transmit power per exposure scenario) may include default values and exception values associated with the tag.

The region configurable RF exposure compliance as described herein may enable the wireless device to have improved communication performance such as an increased throughput, reduced latency, and/or increased transmit range. For example, the region configurable RF exposure compliance as described herein may provide the wireless device with a maximum transmit power limit that matches the values applied in the region in which the wireless device is located rather than a lower value that complies with multiple regions. The wireless device may be more flexible to configure specific parameters for RF exposure compliance for a given region, which may lead to desirable transmit power limits in that given region.

In some cases, some values corresponding to certain RF exposure parameters (e.g., RF exposure limit, time-averaging time window, averaging volume, averaging area, test separation distance, etc.) may be shared among regions, whereas other values corresponding to the RF exposure parameters may be different among the same regions. For example, a set of regions may apply the ICNIRP guidelines (or FCC regulations) and a set of test procedures for certain exposure scenarios (e.g., head exposure and/or extremity exposure). A subset of the regions may apply different test procedures for different exposure scenarios (e.g., body-worn exposure and/or hotspot exposure). For example, some regions may apply a separation distance of 0 mm to test the RF exposure in determining a compliant Pₗᵢₘᵢₜ for body-worn exposure and/or hotspot exposure (or the respective exposure scenario defined by the regulator of the given region), whereas other regions may apply a separation distance of 5 mm to test the RF exposure in determining a compliant Pₗᵢₘᵢₜ for body-worn exposure and/or hotspot exposure. The separate values for the subset of regions may be considered exceptions to default values, which correspond to the value obtained from a given test procedure (e.g., tested with 5 mm separation distance). It will be appreciated that the different separation distances used among regions are merely examples for how the exception values associated with a region may differ from default values associated with another region. Aspects of the present disclosure may be applied to when other RF exposure parameters differ among regions, such as averaging volume for SAR or averaging area for PD, which may result in different maximum time-averaged transmit powers (e.g., Pₗᵢₘᵢₜ) among regions.

To identify the exception values or default values associated with a particular region, region tagging may be applied, where, within a given set of values (e.g., values associated with FCC regulations or ICNIRP guidelines), a unique tag may correspond to certain region(s) that apply the exception values, and the absence of a tag may indicate that the region applies the default values. Exception values may be flagged or tagged in a look-up table that stores values (e.g., values of Pₗᵢₘᵢₜ) mapped to various transmit scenarios (e.g., RAT, frequency band, antenna, antenna group, etc.) and/or exposure scenarios (e.g., head exposure, body-worn exposure, extremity exposure, and/or hotspot exposure).

Correspondingly, parallel sets of exposure limits, each with a unique tag (or no tag for default in some aspects) may be stored in an exposure configuration structure (e.g., database) on the wireless device. In response to identifying the region in which the wireless device is located, the wireless device may check whether exception values or default values apply to the region. For example, the wireless device may identify that an exception tag is associated with the region, and the wireless device may select the matching set of exposure limits carrying that tag, for an otherwise equivalent control set index nomenclature (e.g., device state index (DSI) corresponding to various exposure scenarios). Any region without a tag may use the correspondingly untagged exposure limits, and any region with a tag for which there is no explicitly tagged set of exposure limits in the corresponding table may use the default/untagged set of limits. In other words, a region may apply a mix of default values and exception values, where a tag may indicate respective exception values (if available or configured).

The exception tagging described herein ensures backward compatibility (e.g., for devices that may not implement the exception tagging), memory efficiency (e.g., avoiding tables that share information), and efficient maintenance of the exceptions (e.g., avoiding the maintenance of the tables that share information including effort/time-intensive processes to maintain multiple sets of data with potentially overlapping/duplicate information) for regions that apply exceptions to RF exposure parameters.

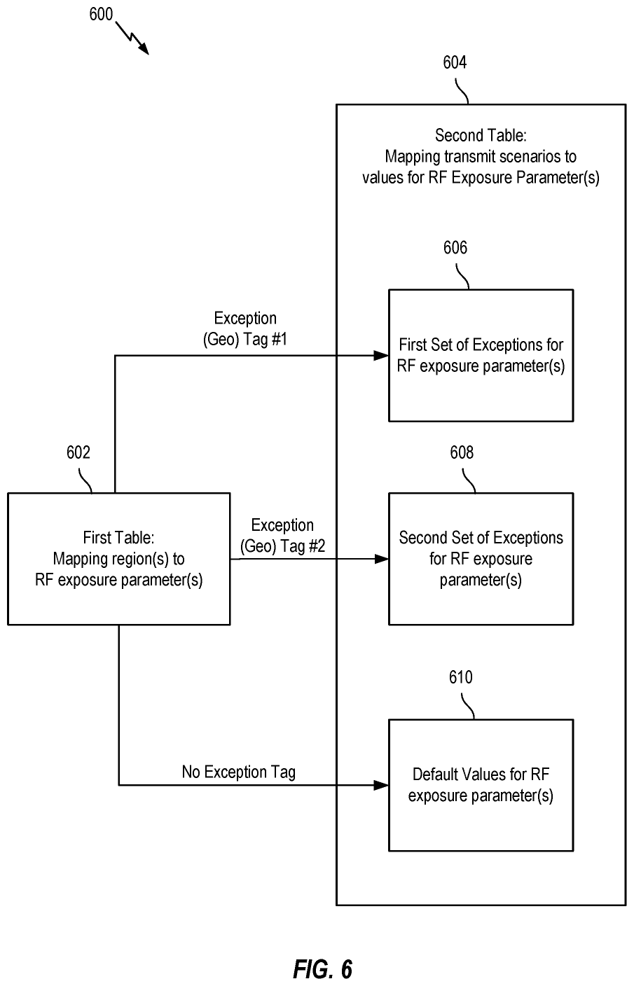

FIG. 6 is a diagram illustrating an example data structure 600 for selecting exception or default values(s) corresponding to certain RF exposure parameter(s) associated with one or more regions. In this example, the data structure 600 may include a first table 602 and a second table 604. The data structure 600 may be stored in the memory of a wireless device, such as the memory 240. In some aspects, the data structure 600 may be converted and/or compressed to a computer-readable dataset format, such as SQLite, JavaScript Object Notation (JSON), Extensible Markup Language (XML), or any other suitable dataset format.

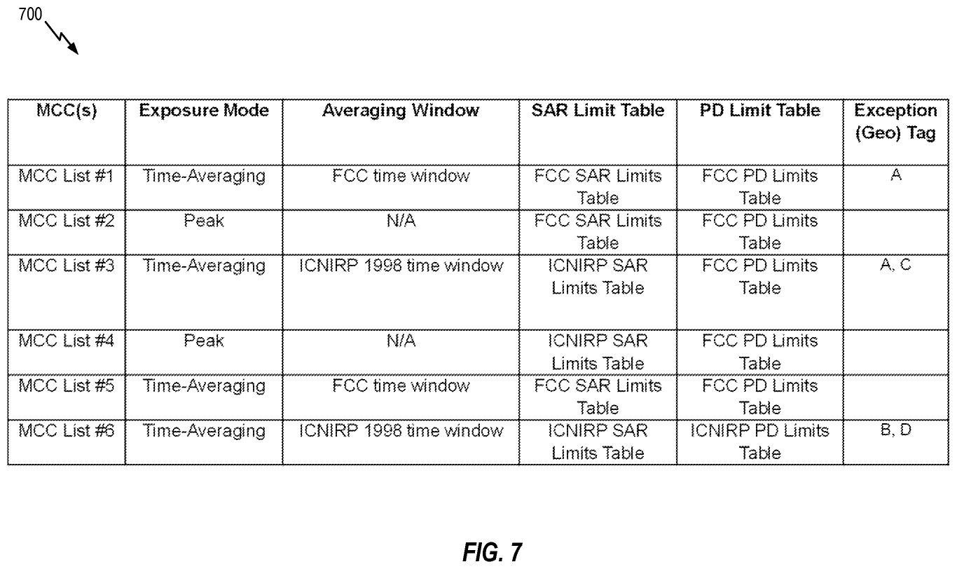

The first table 602 maps regions to various values associated with RF exposure parameters (e.g., values for the time-averaging time window and Pₗᵢₘᵢₜ), for example, as further described herein with respect to FIG. 7. The second table 604 maps various transmit scenarios to values associated with an RF exposure parameter (e.g., Pₗᵢₘᵢₜ). In some cases, the second table 604 may further map the values to various exposure scenarios (e.g., head exposure, body-worn exposure, extremity exposure, and/or hotspot exposure), for example, as further described herein with respect to FIG. 8.

As an example, the first table 602 may indicate that a first region (e.g., a first MCC group corresponding to one or more MCCs) applies a first set of exceptions 606 in the second table 604 with a first exception (geo) tag in the first table 602. The first exception tag maps to the first set of exceptions 606 in the second table 604. The first table 602 may further indicate that a second region (e.g., a second MCC group) applies a second set of exceptions 608 in the second table 604 with a second exception tag. The second exception tag maps to the second set of exceptions 608 in the second table 604. The first table 602 may also indicate a third region applies default values (e.g., without an exception tag, for example, in the second table 604). The absence of an exception tag for the third region in the first table 602 may indicate that the third region applies the default values 610. In some cases, the first region and/or the second region may apply some of the default values 610, for example, where the second table 604 lacks an explicit indication that certain values apply to the first exception tag or the second exception tag, as further described herein with respect to FIG. 8. For example, the default values may be used for certain exposure scenarios, such as head exposure and/or hotspot exposure, whereas the exception values may be used for other exposure scenarios, such as body-worn exposure and/or extremity exposure. While one second table 604 is illustrated, multiple second tables may be implemented. For example, the first table 602 may indicate that a fourth region (e.g., a fourth MCC group corresponding to one or more MCCs) applies a third set of exceptions in another second table (not illustrated) with a third exception tag in the first table 602, and/or the first table 602 may indicate a fifth region applies default values in the another second table.

In certain aspects, the wireless device may associate the region/MCC group with various parameters and modes for RF exposure compliance based on a mapping as provided by a table or any suitable data structure. Thus, the first table 602 and/or the second table 604 may be implemented as a lookup table, a table within a database, or another table or table-like structure. In other aspects, the first table 602 and/or the second table 604 may each be respectively implemented by another type of data structure or element within a dataset. In some aspects, information may be received by or loaded into the first wireless device 102 in one form and stored by the first wireless device 102 in another form. For example, the wireless device 102 may be configured to receive or load the tables 602 and 604 and store the information therein (e.g., in a similar, table-like form, or in another form or structure, for example in the memory 240).

FIG. 7 is a table 700 illustrating example mappings between location (region) information (for example, MCC lists, e.g., MCC groups) and various RF exposure parameters and exceptions thereof. The table 700 may be representative of the first table 602 described herein with respect to FIG. 6. In this example, each of the MCC lists may include one or more MCCs, and an MCC list may correspond to a particular country or region, such as Canada, the United States, or the EU. An MCC list may be representative of a particular country or region. Each “list” may include or be representative of one or multiple MCCs. The wireless device may identify the current MCC of the wireless network in which the wireless device is operating, and the wireless device may identify the MCC list to which the current MCC corresponds. Based on the current MCC, the wireless device may select the respective exposure mode (e.g., time-averaging mode or peak mode), time window (e.g., FCC time window or ICNIRP time window), SAR limit table (e.g., FCC SAR Limits table or ICNIRP SAR Limits Table), PD limit table (e.g., FCC PD Limits Table or ICNIRP PD Limits Table), and/or Exception Tag (e.g., A, B, C, D, etc.) corresponding to the identified MCC and/or MCC list. As an example, the FCC SAR Limits table may be representative of the second table 604, the ICNIRP SAR Limits Table may be representative of another second table, the FCC PD Limits Table may be representative of yet another second table, etc.

The table 700 may map the MCC lists to specific table identifiers (e.g., FCC SAR Limits table or ICNIRP SAR Limits Table) associated with the SAR Limit Table and/or the PD Limit Table. A table identifier may be a unique label or identifier associated with a particular table, such as the second table 604 in FIG. 6 or the table 800 as further described herein with respect to FIG. 8.

Certain exception tags (e.g., A, B, C, D, etc.) may correspond to a specific SAR table and/or PD table. For example, a value of ‘A’ or ‘B’ for the exception tag may correspond to exceptions provided in the ICNIRP SAR limits table, whereas a value of ‘C’ or ‘D’ for the exception tag may correspond to exceptions provided in the ICNIRP PD limits table. Certain exception tags (e.g., A and B) may correspond to a specific exposure scenario in which exception values are applied in a particular table (e.g., the ICNIRP SAR Limits Table). For example, a value of ‘A’ for the exception tag may correspond to exceptions in a body-worn exposure scenario, whereas a value of “B’ for the exception tag may correspond to exceptions in an extremity exposure scenario, for example, as depicted in FIG. 8. In some cases, a particular exception tag may correspond to a SAR table and a PD table.

In certain aspects, certain exception tags (e.g., A and C) may correspond to the same exposure scenario and the same RF exposure limit table. For example, tags A and C may represent different transmit power limits for the same exposure scenario in the ICNIRP SAR Table. The different exception values associated with the A and C tags may allow the wireless device to select power limits (e.g., either the limits corresponding to A or C) for any of various scenarios or criteria, for example, including an updated regulation or guideline (or expected update to a regulation or guideline), different transmission scenarios (e.g., concurrent transmissions with multiple RATs), different traffic (e.g., heavy traffic versus light traffic), different duty cycles, changes in network or channel conditions, different priorities, etc. Thus, in certain scenarios, additional information may be used to select between several potential tags. In some aspects, a priority of one or more tags may be used to select between multiple tags. In certain aspects, the tags are configured such that tags will never conflict (e.g., are used in different tables and/or for different DSIs, etc.).

As an example, the wireless device may identify that its current MCC corresponds to MCC List #4, and based on this identified region, the wireless device may select peak exposure mode, ICNIRP SAR Limits Table and FCC PD Limits Table, as the mode and parameter values for determining RF exposure compliance without an exception tag. The absence of an exception tag mapping to MCC list #4 indicates that the default values are used in the ICNIRP SAR Limits Table and/or FCC PD Limits Table.

As another example, the wireless device may identify that its current MCC corresponds to MCC List #3, and based on this identified region, the wireless device may select time-averaging mode, ICNIRP time windows, ICNIRP SAR Limits Table and FCC PD Limits Table, as the mode and parameter values for determining RF exposure compliance with exception tags A and C. The presence of the exception tag mapping to MCC list #3 indicates that the respective exception values may be used in the ICNIRP SAR Limits Table and/or FCC PD Limits Table. In some cases, the exception values may depend on the current exposure scenario exhibited by the wireless device.

In some aspects, a tag (and the corresponding values in the respective table) will always be applied when a location (e.g., a particular region or MCC) in the corresponding MCC list is identified. In some such scenarios, the MCCs in MCC List #1 and MCC List #5 will not overlap. In other aspects, one or more corresponding tags (and the corresponding values in the respective table) may be selectively applied. In some aspects, a tag is included for every potential location, for example when a default value is not indicated by the lack of a tag.

In some aspects, other methods or structures for correlating a location with a tag or exception is implemented. For example, the table 700 may store mappings between location information and the respective exposure mode, time window, SAR limit table, and PD limit table, while mapping(s) between locations and exceptions in SAR and/or PD limit table(s) is stored in another table or structure.

Those of skill in the art will understand that the parameters illustrated in FIG. 7 are merely examples. Additional parameters or categories of parameters may be used in addition to or instead of those illustrated. For example, a region may be represented by an identifier other than an MCC, and/or the identifiers may be individually represented instead of included in lists. As another example, a method of calculating exposure other than time averaging may be indicated, and parameters relevant thereto may be provided. Similarly, metrics for exposure other than SAR and PD may be included. As yet another example, the exception tags may be correlated with information other than a location. In some aspects, a device may have different physical configurations, such as an open or flat state (e.g., fully open) and a closed or folded state (e.g., fully closed or folded). One of these states may correspond to a default state (with corresponding default values), and another of these states may correspond to an exception (e.g., using a tag with corresponding exception values), or both states may correspond to respective tags (with corresponding exception values). Such tags may be used instead of tags corresponding to location, or may be used in addition. When using the tags to access information in the second table 604, a single (e.g., highest priority) tag may be used, or there may be values in the second table 604 which correspond to combinations of tags. In some aspects, tags may be implemented for any scenario or attribute which may correlate with different values of an RF exposure parameter (e.g., Pₗᵢₘᵢₜ).

Further, the values need not be stored in a look-up table, but can be stored, accessed, retrieved, determined in real-time, etc. using any number of data structures, hardware and/or software means. Additionally, while one “column” of tags is illustrated, multiple “columns” or sets of tags may be included.

FIG. 8 is a table 800 illustrating example mappings between various transmit scenarios and values associated with a RF exposure parameter (e.g., Pₗᵢₘᵢₜ). Table 800 may be representative of the second table 604 as described herein with respect to FIG. 6. Pₗᵢₘᵢₜ represents the maximum time-averaged transmit power in compliance with an RF exposure limit (e.g., after accounting for device uncertainty) for a given exposure scenario and/or transmit scenario (e.g., RAT, frequency band, antenna, and/or antenna groups). For example, the table 800 may be an example of an FCC SAR Limits table, an ICNIRP SAR Limits Table, an FCC PD Limits Table, or an ICNIRP PD Limits Table, as depicted in FIG. 7.

In this example, certain default values for Pₗᵢₘᵢₜ (e.g., p₀-p₂₃) may be assigned to various exposure scenarios (e.g., head scenario, body scenario, extremity scenario, hotspot scenario) and/or exposure categories (e.g., head or non-head categories) per transmit scenario including a specific frequency band (e.g., B0, B1, B2, etc.) of a RAT (e.g., CDMA, Long Term Evolution (LTE), NR, etc.) for an antenna (e.g., a radio or antenna module) and/or antenna group. The various exposures scenarios shown in FIG. 8 may correspond to one or more DSIs, for example, as described herein with respect to FIG. 4. The wireless device may identify an exposure scenario(s) by the corresponding DSI and apply the default values or exception values associated with the DSI shown in the table 800. Certain exception values for Pₗᵢₘᵢₜ (e.g., p₂₄-p₃₅) may be assigned to specific exposure scenarios (e.g., body scenario and/or extremity scenario) and/or exposure categories per transmit scenario, where a particular exception may be indicated by an exception tag used in a counterpart table (e.g., the first table 602) to map a region to a particular exception. One DSI is illustrated as being associated with each tag (‘A’ and ‘B’), but in some implementations a tag may be associated with several DSIs. For example, the tag ‘A’ may be associated not only with the body-worn DSI, as illustrated, but also with the extremity DSI. Thus, another “column” may be included that contains the tag ‘A’, the extremity DSI, and corresponding values of Pₗᵢₘᵢₜ for the various tech/band combinations. It will be understood that the Pₗᵢₘᵢₜ values in table 800 may be based on or may have been derived from the measurements described with respect to FIG. 5.

When a region is associated with a particular exception tag (e.g., A or B), the wireless device may apply the exception values corresponding to the exception tag. The exception values may be associated with a particular exposure scenario (e.g., body scenario or extremity scenario) or exposure category. For example, suppose the wireless device identifies that it is located in a region applying an exception to the Pₗᵢₘᵢₜ values for body-worn exposure, where such exception values correspond to the exception tag of ‘A’. The wireless device may apply the exception values corresponding to the exception tag of ‘A’ in a body-worn scenario, and for other exposure scenarios (e.g., head, extremity, and hotspot), the wireless device may apply the default values, which may be shared by other regions, allowing for efficient memory usage for the region configurable RF exposure compliance described herein. That is, the exception values (e.g., p₂₄-p₂₉) for the body scenario may replace or override the default values (e.g., p₆-p₁₁) for the counterpart body scenario. In some cases, a particular exception tag (e.g., A) and the corresponding exceptions may apply to multiple exposure scenarios (not shown).

As described herein with respect to FIGS. 6 and 7, a separate table (e.g., the first table 602 or the table 700) may indicate whether a region is associated with a particular exception tag (e.g., A). The same value of the exception tag (e.g., A) may be used in the counterpart table (e.g., the second table 604 or the table 800) mapping transmit scenarios to default and/or exception values of an RF exposure parameter to indicate which exception values apply to that region and/or other regions.

In certain aspects, the various default values and/or exception values may correlate with the same RF exposure limit (e.g., 2.0 W/kg), but differ due to different testing parameters (which may be specified by a regulator of a region and vary by region), such as different averaging volumes (e.g., 1 gram or 10 grams), averaging areas (e.g., 4 cm² or 20 cm²), and/or separation distances (e.g., 0 mm or 5 mm). The various default values and/or exception values may be determined via testing as described herein with respect to FIG. 5. For example, the default values for the body-worn exposure scenarios may be determined using a separation distance of 5 mm, whereas the exception values for the body-worn exposure scenarios (under the exception tag ‘A’) may be determined using a separation distance of 0 mm.

FIG. 8 illustrates that a different value (e.g., p₀-p₃₅) of Pₗᵢₘᵢₜ may be assigned to each combination of exposure scenario, exposure category, RAT, band, antenna, and/or antenna group. In some examples, however, the Pₗᵢₘᵢₜ for two or more combinations may be the same.

Those of skill in the art will understand that mapping of values to an RF exposure parameter (e.g., Pₗᵢₘᵢₜ) illustrated in FIG. 8 are merely examples. Other parameters (e.g., backoff factors, or a power limit that corresponds to Pₗᵢₘᵢₜ multiplied by a corresponding backoff factor for a respective combination of RAT, band, exposure scenario, exposure category, antenna, antenna group, etc.) or categories of parameters (e.g., antenna groups, antenna groupings, or exposure categorizations) may be used in addition to or instead of those illustrated.

In certain aspects, the various values for the RF exposure parameters described herein may represent the regulatory values for the time window, SAR limit, and/or PD limit for the respective MCC/region. In such cases, the wireless device may select values which are less than the regulatory values. In certain cases, the various values may represent values which are less than the regulatory values for the respective MCC/region, such that the wireless device may select the identical values of an MCC list for determining RF exposure compliance in a particular region.

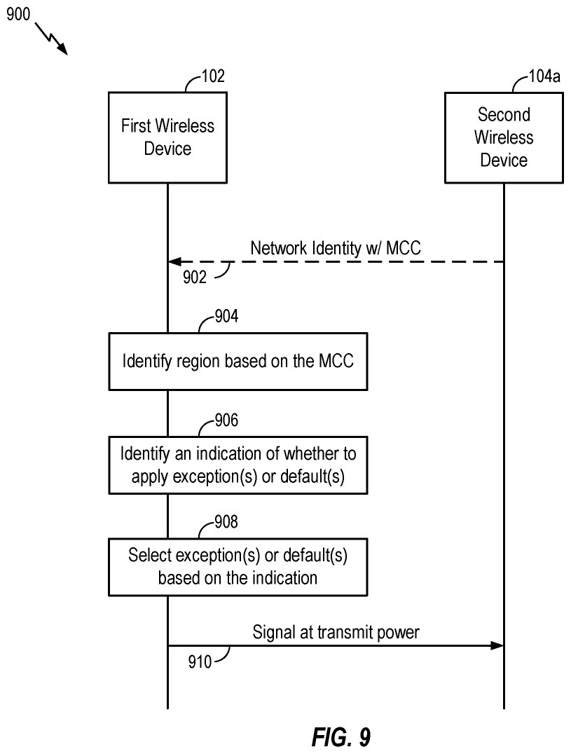

FIG. 9 is a signaling flow illustrating example operations 900 for region configurable RF exposure compliance with some exceptions to default values. At activity 902, the first wireless device 102 may receive, from the base station 104a, an indication of a wireless network identity (e.g., a PLMN identity), which may include the MCC, or may otherwise receive information that can be used to determine a region in which the first wireless device 102 is located. For example, the first wireless device 102 may receive system information (e.g., a system information block (SIB)) that indicates the PLMN identity of the wireless network to which the base station 104a belongs.

At activity 904, the first wireless device 102 may identify the region in which the first wireless device 102 is located, for example, based on the MCC received at activity 902. As an example, the first wireless device 102 may identify a region associated with a list of MCCs, which includes the MCC received at activity 902, such as one of the MCC lists depicted in FIG. 7.

At activity 906, the first wireless device 102 may identify an indication (e.g., an exception tag or lack thereof), associated with the identified region, of whether to apply exception values (e.g., p₂₄-p₃₅ in table 800) or default values (e.g., p₀-p₂₃ in table 800) associated with RF exposure parameters. For example, the wireless device may access a first table (e.g., the first table 602 or the table 700) that provides a mapping of regions to the indication, and the wireless device may search the first table for the indication.

At activity 908, the first wireless device 102 may select the exception values or the default values based on the indication. In some cases, the first wireless device 102 may select the exception values in response to the indication indicating to apply the exception values for the region. In certain cases, the first wireless device 102 may select the default values in response to the indication indicating to apply default values for the region (e.g., a tag corresponding to default values or the lack of a tag).

At activity 910, the first wireless device 102 may transmit a signal at a transmit power based at least in part on the exception values and/or the default values. For example, the first wireless device 102 may determine a maximum allowed transmit power for a future time interval (e.g., the future time interval 306) that complies with a time-averaged RF exposure limit based on a value associated with a maximum time-averaged transmit power (e.g., Pₗᵢₘᵢₜ). The transmit power used at activity 910 may be less than or equal to the maximum allowed transmit power. In some cases, the exception values and/or the default values may be associated with Pₗᵢₘᵢₜ, for example, as depicted in FIG. 8.

Other methods of identifying the region may be performed (e.g., instead of or in addition to the activities described with respect to 902 and 904). For example, the first wireless device 102 may receive a region indicator other than an MCC from the radio access network, and/or the first wireless device 102 may determine a region based on a location determined according to signals received from a global navigation satellite system (GNSS), such as the global positioning system (GPS), global navigation satellite system (GLONASS), or Galileo, or according to signals from another type of satellite constellation, such as NTN communications. In certain cases, the first wireless device 102 may determine the region based on a WLAN positioning system, which can use access points to detect where the wireless device is located, for example, through a database of access point locations.

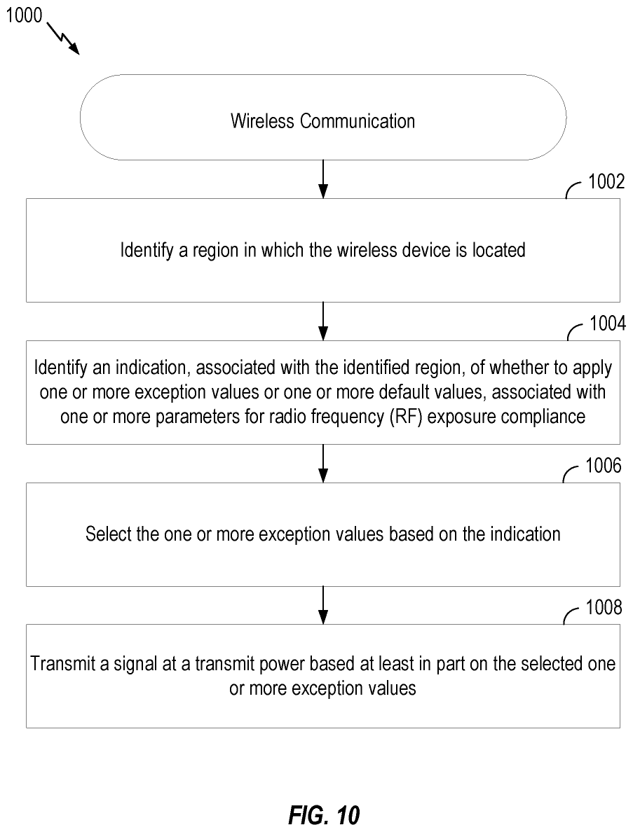

FIG. 10 is a flow diagram illustrating example operations 1000 for wireless communication. The operations 1000 may be performed, for example, by a wireless device (e.g., the first wireless device 102 in the wireless communication network 100). The operations 1000 may be implemented as software components that are executed and run on one or more processors (e.g., the processor 210 and/or the modem 212 of FIG. 2). Further, the transmission and/or reception of signals by the wireless device in the operations 1000 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission, e.g., via the RX path 216 or TX path 214.

The operations 1000 may optionally begin, at block 1002, where the wireless device may identify a region in which the wireless device is located. In certain cases, the identification of the region may be based on a MCC of a wireless network (such as a PLMN). For example, the wireless device may receive, from a network entity (e.g., the base station 104a), system information indicating a wireless network identity, which may include an MCC of a wireless network, and the wireless device may identify the region based on the MCC, as described herein. In aspects, the region may include one or more countries (e.g., the United States, Canada, or the EU) and/or be associated with one or more MCCs. In certain cases, identification of the region at block 1002 may include the wireless device identifying that the MCC is in a list of MCCs corresponding to the region, for example, as described herein with respect to FIG. 7. For certain aspects, to identify the region, the wireless device may identify the region based on a received MCC.

At block 1004, the wireless device may identify an indication (e.g., the exception tag in table 800), associated with the identified region, of whether to apply one or more exception values (e.g., p₂₄-p₃₅ in table 800) or one or more default values (e.g., p₀-p₂₃ in table 800), associated with one or more parameters for RF exposure compliance. For example, the wireless device may access a first table (e.g., the first table 602 or the table 700) that provides a mapping of regions to the indication, and the wireless device may search the first table for the indication. The indication may be associated with the MCC or a list of MCCs including the received MCC.

At block 1006, the wireless device may select the one or more exception values based on the indication. The indication may correspond to a second table (e.g., the second table 604 or the table 800) that provides a mapping of default values and/or exception values associated with at least one of the parameters per transmit scenario (e.g., frequency band, RAT, antenna, antenna group, or any combination thereof). For example, the wireless device may access the second table that maps the indication to the exception values and/or default values.

At block 1008, the wireless device may transmit a signal at a transmit power based at least in part on the selected one or more exception values. For example, the wireless device may transmit the signal to a second wireless communication device (e.g., any of the second wireless devices 104 depicted in FIG. 1) via any of various RATs. The signal may indicate any of various information, such as data or control information. The wireless device may transmit the signal at the transmit power in compliance with an RF exposure limit. As an example, the wireless device may determine the maximum allowed transmit power for a future time interval (e.g., the future time interval 306) based on a maximum time-averaged transmit power (Pₗᵢₘᵢₜ) associated with the exception values, for example, as described herein with respect to FIG. 3. The wireless device may transmit the signal at the transmit power, which is less than or equal to the maximum allowed transmit power.

In certain aspects, the indication may include a tag (e.g., a flag, bit flag, bitmap, field, etc.) associated with a particular set of the one or more exception values among a plurality of sets of the one or more exception values. The tag may have a specific value (e.g., ‘A’, ‘B’, ‘0’, or ‘1’) corresponding to the particular set of exception values, such as exception values associated with a particular exposure scenario and/or exposure category. Each of the sets of exception values may represent exception values associated with one or more different exposure scenarios and/or exposure categories. To select the exception values, the wireless device may select the particular set of the one or more exception values based on a value of the tag corresponding to the particular set. The presence of the tag for the identified region in a look-up table (e.g., the table 700) may indicate to apply the one or more exception values, whereas the absence of the tag for the identified region in the look-up table may indicate to apply the one or more default values.

For certain aspects, identifying the indication and selecting the exception values may be performed using any of various data structures, such as a multi-table architecture as depicted in FIG. 6. For example, to identify the indication, the wireless device may search for the indication in a first look-up table (e.g., the first table 602 or the table 700) mapping the region to a second look-up table (e.g., the second table 604 or the table 800) including the one or more exception values and the one or more default values. To select the one or more exception values, the wireless device may select the one or more exception values in the second look-up table when the indication indicates to apply the one or more exception values. In certain cases, the wireless device may select the one or more default values in the second look-up table when the indication indicates to apply the default values. As an example, the second look-up table may map a plurality of frequency bands (e.g., frequency bands in various transmit scenarios), RATs, antennas, antenna groups, or any combination thereof to one or more maximum time-averaged transmit powers (e.g., p₀-p₃₅) corresponding to different RF exposure scenarios (e.g., head exposure, body exposure, extremity exposure, hotspot exposure, etc.).

In certain aspects, the exception values may represent exceptions to default values corresponding to certain guidelines and/or regulations for limiting human exposure to RF energy. For example, the one or more exception values may represent exceptions to maximum time-averaged transmit powers (e.g., Pₗᵢₘᵢₜ) corresponding to at least one of guidelines (e.g., ICNIRP guidelines), regulations (e.g., FCC regulations), or testing procedures for limiting human exposure to RF energy. The guidelines may include guidelines as provided by the ICNIRP or specifications as provided by a regulator (e.g., FCC for the United States or ISED for Canada) associated with the identified region. For certain aspects, the one or more exception values may be derived or determined from measurements of RF exposure under one or more different test conditions than the one or more default values, such as the RF exposure measurements performed as described herein with respect to FIG. 5. The one or more different test conditions may include a different averaging volume, a different averaging area, and/or a different separation distance (spacing) between the wireless device and human tissue or a model of human tissue.

In some cases, the one or more exception values may be derived from different device usage states or physical configuration states than the one or more default values. For example, suppose the wireless device is a flip or folding phone that uses different antenna(s) or antenna group(s) when the phone is flipped open or unfolded versus when the phone is closed. The different usage states or physical configuration states may include an open state and a closed state associated with the wireless device. The open state may correspond to when the wireless device is flipped open or unfolded, and the closed state may correspond to when the wireless device is closed. The different configuration states may correspond to various physical attributes associated with different models of a wireless device, for example, a glass back versus a metal back versus a plastic back, a curved edge screen versus a flat screen, different cases, different antenna configurations, etc.

In certain aspects, the one or more exception values may be associated with a particular exposure scenario or multiple exposure scenarios. For example, the particular exposure scenario may include body-worn exposure. The exception values may be associated with the body-worn exposure scenario, and the default values may be associated with the other exposure scenarios, such as head exposure, extremity exposure, and/or hotspot exposure.

The parameter(s) for RF exposure compliance may include any of the parameters (e.g., a time-averaging time window, an RF exposure limit, a maximum time-averaged transmit power, etc.) described herein. As an example, the one or more parameters for RF exposure compliance may include a maximum time-averaged transmit power (e.g., Pₗᵢₘᵢₜ) associated with an RF exposure limit (e.g., 1.6 W/kg SAR averaged over 1 gram).

In certain aspects, the wireless device may be configured with a table including the exception values and/or default values, for example, as described herein with respect to FIGS. 6-8. In some cases, the wireless device may receive the table, for example, from the manufacturer (or any other entity) as a preconfiguration or reconfiguration (e.g., update). As an example, the wireless device may receive a table including the one or more exception values and the one or more default values. The wireless device may store information in a memory (e.g., the memory 240) of the wireless device based on the received table. To select the one or more exception values (or the one or more default values), the wireless device may select the one or more exception values (or the one or more default values) using the stored information.

Aspects of the present disclosure may be applied to any of various wireless communication devices (wireless devices) that may emit RF signals causing exposure to human tissue, such as a base station and/or a CPE, performing the RF exposure compliance described herein.

### Example Communications Device

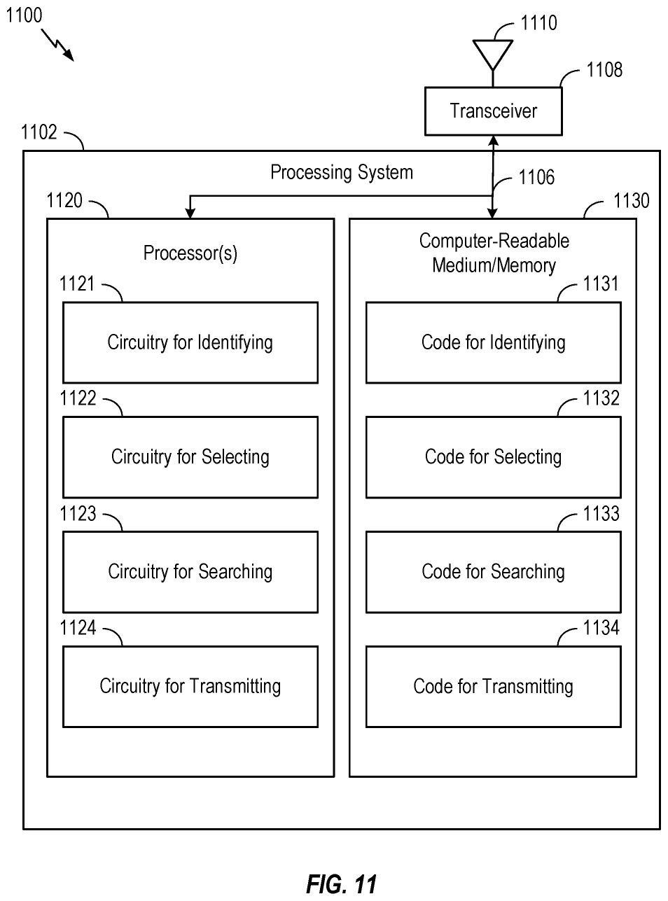

FIG. 11 depicts aspects of an example communications device 1100. In some aspects, communications device 1100 is a wireless communication device, such as the first wireless device 102 described above with respect to FIGS. 1 and 2.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of any of the processor 210 and/or the modem 212, as described with respect to FIG. 2. The one or more processors 1120 are coupled to a computer-readable medium/memory 1130 via a bus 1106. In certain aspects, the computer-readable medium/memory 1130 is configured to store instructions (e.g., computer-executable code) that when executed by the one or more processors 1120, cause the one or more processors 1120 to perform the operations 1000 described with respect to FIG. 10, or any aspect related to the operations described herein. Note that reference to a processor performing a function of communications device 1100 may include one or more processors performing that function of communications device 1100.

In the depicted example, computer-readable medium/memory 1130 stores code (e.g., executable instructions) for identifying 1131, code for selecting 1132, code for searching 1133, code for transmitting 1134, or any combination thereof. Processing of the code 1131-1134 may cause the communications device 1100 to perform the operations 1000 described with respect to FIG. 10, or any aspect related to operations described herein.

The one or more processors 1120 include circuitry configured to implement (e.g., execute) the code stored in the computer-readable medium/memory 1130, including circuitry for identifying 1121, circuitry for selecting 1122, circuitry for searching 1123, circuitry for transmitting 1124, or any combination thereof. Processing with circuitry 1121-1124 may cause the communications device 1100 to perform the operations 1000 described with respect to FIG. 10, or any aspect related to operations described herein.

Various components of the communications device 1100 may provide means for performing the operations 1000 described with respect to FIG. 10, or any aspect related to operations described herein. For example, means for transmitting, sending or outputting for transmission may include the TX path 214 and/or antenna(s) 218 of the first wireless device 102 illustrated in FIG. 2 and/or transceiver 1108 and antenna 1110 of the communications device 1100 in FIG. 11. Means for receiving or obtaining may include the RX path 216 and/or antenna(s) 218 of the first wireless device illustrated in FIG. 2 and/or transceiver 1108 and antenna 1110 of the communications device 1100 in FIG. 11. Means for identifying, means for selecting, and/or means for searching may include a processor, such as the processor 210 and/or modem 212 depicted in FIG. 2 and/or the processor(s) 1120 in FIG. 11.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive multiple-input, multiple-output (MIMO) processors, modulators, demodulators, and the like, such as depicted in the examples in FIG. 2.

### Example Aspects

Implementation examples are described in the following numbered clauses:

Aspect 1: A method of wireless communication by a wireless device, comprising: identifying a region in which the wireless device is located; identifying an indication, associated with the identified region, of whether to apply one or more exception values or one or more default values, associated with one or more parameters for radio frequency (RF) exposure compliance; selecting the one or more exception values based on the indication; and transmitting a signal at a transmit power based at least in part on the selected one or more exception values.

Aspect 2: The method of Aspect 1, wherein the indication includes a tag associated with a particular set of the one or more exception values among a plurality of sets of the one or more exception values.

Aspect 3: The method of Aspect 2, wherein selecting the one or more exception values comprises selecting the particular set of the one or more exception values based on a value of the tag corresponding to the particular set.

Aspect 4: The method of Aspect 2 or 3, wherein: a presence of the tag for the identified region in a look-up table indicates to apply the one or more exception values; and an absence of the tag for the identified region in the look-up table indicates to apply the one or more default values.

Aspect 5: The method according to any of Aspects 1-4, wherein: identifying the indication comprises searching for the indication in a first look-up table mapping the region to a second look-up table comprising the one or more exception values and the one or more default values; selecting the one or more exception values comprises selecting the one or more exception values in the second look-up table when the indication indicates to apply the one or more exception values; and the method further comprises selecting the one or more default values in the second look-up table when the indication indicates to apply the default values.

Aspect 6: The method of Aspect 5, wherein the second look-up table maps a plurality of frequency bands, radio access technologies, antennas, antenna groups, or any combination thereof to one or more maximum time-averaged transmit powers corresponding to different RF exposure scenarios.

Aspect 7: The method according to any of Aspects 1-6, wherein the one or more exception values represent exceptions to maximum time-averaged transmit powers corresponding to at least one of guidelines or regulations for limiting human exposure to RF energy.

Aspect 8: The method of Aspect 7, wherein the guidelines include guidelines as provided by the International Commission on Non-Ionizing Radiation Protection (ICNIRP) or specifications as provided by a regulator.

Aspect 9: The method according to any of Aspects 1-8, wherein the one or more exception values are derived from measurements of RF exposure under one or more different test conditions than the one or more default values.

Aspect 10: The method of Aspect 9, wherein the one or more different test conditions include a different separation distance between the wireless device and human tissue or a model of human tissue.

Aspect 11: The method according to any of Aspects 1-10, wherein the one or more exception values are derived from different device usage states or physical configuration states than the one or more default values.

Aspect 12: The method according to any of Aspects 1-11, wherein the one or more exception values are associated with a particular exposure scenario.

Aspect 13: The method of Aspect 12, wherein the particular exposure scenario includes body-worn exposure.

Aspect 14: The method according to any of Aspects 1-13, wherein the one or more parameters for RF exposure compliance include a maximum time-averaged transmit power associated with an RF exposure limit.

Aspect 15: The method according to any of Aspects 1-14, further comprising receiving a table comprising the one or more exception values and the one or more default values, and storing information in a memory of the wireless device based on the received table, wherein the selecting comprises selecting the one or more exception values using the stored information.

Aspect 16: The method according to any of Aspects 1-15, wherein the region is identified based on a received mobile country code (MCC), and wherein the indication is associated with the MCC or a list of MCCs including the received MCC.

Aspect 17: An apparatus, comprising: one or more memories collectively storing executable instructions; and one or more processors coupled to the one or more memories, the one or more processors being collectively configured to execute the executable instructions to cause the apparatus to perform a method in accordance with any of Aspects 1-16.

Aspect 18: An apparatus, comprising means for performing a method in accordance with any of Aspects 1-16.

Aspect 19: A non-transitory computer-readable medium comprising computer-executable instructions that, when executed by one or more processors of a processing system, cause the processing system to perform a method in accordance with any of Aspects 1-16.

Aspect 20: A computer program product embodied on a computer-readable storage medium comprising code for performing a method in accordance with any of Aspects 1-16.

Aspect 21: A method of wireless communication by a wireless device, comprising: identifying a state of the wireless device, wherein the state is selected from one of several states that each correspond to a respective part of a user of the wireless device which is exposed to electromagnetic radiation and a state in which the wireless device is away from human tissue; selecting, from a data structure, one of several sets of power limits for radio frequency (RF) exposure compliance stored in the data structure, wherein the selecting is based on the identified state, and wherein each set includes power limits for a plurality of frequency bands, radio access technologies, and antennas or antenna groups; and transmitting a signal at a transmit power based at least in part on a power limit included in the selected set.

Aspect 22: The method of Aspect 21, wherein the sets of power limits each correspond to a respective physical configuration of the wireless device, wherein a first physical configuration is representative of the wireless device being fully open and wherein a second physical configuration is representative of the wireless device being fully folded or closed.

Aspect 23: The method of Aspect 21, wherein the several sets of power limits correspond to one list of mobile country codes (MCCs) in a plurality of lists of MCCs.

Aspect 24: The method of Aspect 23, wherein the plurality of lists of MCCs are stored in the data structure.

Aspect 25: The method of Aspect 21, wherein the several sets of power limits correspond to a combination of an exposure mode and an averaging window in plurality of combinations of possible exposure modes and averaging windows.

Aspect 26: The method of Aspect 25, wherein the plurality of combinations are stored in the data structure.

Aspect 27: The method of Aspect 26, wherein the power limits in the several sets of power limits correspond to a specific absorption rate (SAR).

Aspect 28: The method of Aspect 21, wherein the several states comprise device state indexes.

Aspect 29: The method of Aspect 21, wherein the respective parts of the user comprise a left side of a head and a ride side of a head.

### ADDITIONAL CONSIDERATIONS

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements, for example one or more dies and/or other components, packaged together.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 10.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
identifying a region in which the wireless device is located;
identifying an indication, associated with the identified region, of whether to apply one or more exception values or one or more default values, associated with one or more parameters for radio frequency (RF) exposure compliance;
selecting the one or more exception values based on the indication; and
transmitting a signal at a transmit power based at least in part on the selected one or more exception values.

2. The method of claim 1, wherein the indication includes a tag associated with a particular set of the one or more exception values among a plurality of sets of the one or more exception values.

3. The method of claim 2, wherein selecting the one or more exception values comprises selecting the particular set of the one or more exception values based on a value of the tag corresponding to the particular set.

4. The method of claim 2, wherein:
a presence of the tag for the identified region in a look-up table indicates to apply the one or more exception values; and
an absence of the tag for the identified region in the look-up table indicates to apply the one or more default values.

5. The method of claim 1, wherein:
identifying the indication comprises searching for the indication in a first look-up table mapping the region to a second look-up table comprising the one or more exception values and the one or more default values;
selecting the one or more exception values comprises selecting the one or more exception values in the second look-up table when the indication indicates to apply the one or more exception values; and
the method further comprises selecting the one or more default values in the second look-up table when the indication indicates to apply the default values.

6. The method of claim 5, wherein the second look-up table maps a plurality of frequency bands, radio access technologies, antennas, antenna groups, or any combination thereof to one or more maximum time-averaged transmit powers corresponding to different RF exposure scenarios.

7. The method of claim 1, wherein the one or more exception values represent exceptions to maximum time-averaged transmit powers corresponding to at least one of guidelines or regulations for limiting human exposure to RF energy.

8. The method of claim 7, wherein the guidelines include guidelines as provided by the International Commission on Non-Ionizing Radiation Protection (ICNIRP) or specifications as provided by a regulator.

9. The method of claim 1, wherein the one or more exception values are derived from measurements of RF exposure under one or more different test conditions than the one or more default values.

10. The method of claim 9, wherein the one or more different test conditions include a different separation distance between the wireless device and human tissue or a model of human tissue.

11. The method of claim 1, wherein the one or more exception values are derived from different device usage states or physical configuration states than the one or more default values.

12. The method of claim 1, wherein the one or more exception values are associated with a particular exposure scenario.

13. The method of claim 12, wherein the particular exposure scenario includes body-worn exposure.

14. The method of claim 1, wherein the one or more parameters for RF exposure compliance include a maximum time-averaged transmit power associated with an RF exposure limit.

15. The method of claim 1, further comprising receiving a table comprising the one or more exception values and the one or more default values, and storing information in a memory of the wireless device based on the received table, wherein the selecting comprises selecting the one or more exception values using the stored information.

16. The method of claim 1, wherein the region is identified based on a received mobile country code (MCC), and wherein the indication is associated with the MCC or a list of MCCs including the received MCC.

17. An apparatus for wireless communication, comprising:
one or more memories collectively storing executable instructions; and
one or more processors coupled to the one or more memories, the one or more processors being collectively configured to execute the executable instructions to cause the apparatus to:
identify a region in which the apparatus is located;
identify an indication, associated with the identified region, of whether to apply one or more exception values or one or more default values, associated with one or more parameters for radio frequency (RF) exposure compliance;
select the one or more exception values based on the indication; and
control transmission of a signal at a transmit power based at least in part on the selected one or more exception values.

18. The apparatus of claim 17, wherein the indication includes a tag associated with a particular set of the one or more exception values among a plurality of sets of the one or more exception values.

19. The apparatus of claim 18, wherein:
a presence of the tag for the identified region in a look-up table indicates to apply the one or more exception values; and
an absence of the tag for the identified region in the look-up table indicates to apply the one or more default values.

20. An apparatus for wireless communication, comprising:
means for identifying a region in which the apparatus is located;
means for identifying an indication, associated with the identified region, of whether to apply one or more exception values or one or more default values, associated with one or more parameters for radio frequency (RF) exposure compliance;
means for selecting the one or more exception values based on the indication; and
means for transmitting a signal at a transmit power based at least in part on the selected one or more exception values.
